(19) United States
(12) Patent Application Publication
(10) Pub. No.: US 2022/0134508 A1
(43) Pub. Date: May 5, 2022

(54) ROLLER BURNISHING TOOL FOR TREATING A WORKPIECE SURFACE

(71) Applicant: Guehring KG, Albstadt (DE)

(72) Inventor: Gerd HECKEL, Puschendorf (DE)

(21) Appl. No.: 17/453,701

(22) Filed: Nov. 5, 2021

Related U.S. Application Data
(63) Continuation of application No. PCT/DE2020/100340, filed on Apr. 27, 2020.

(30) Foreign Application Priority Data
May 7, 2019 (DE) 10 2019 111 784.4

(51) Int. Cl. B24B 39/02; B23P 9/02

(52) U.S. Cl. CPC B24B 39/023; B23P 9/02

(57) ABSTRACT

The invention relates to a roller burnishing tool (1) for treating a workpiece surface, comprising a base body (12) having at least one roller holder (2) which is arranged in a radially adjustable manner, wherein a burnishing roller (3) is arranged on each roller holder (2) in a rotationally movable manner, and wherein at least one burnishing roller (3) has an external surface with a rough working section (4) having a predetermined roughness depth.

The invention relates to a roller burnishing tool for treating a workpiece surface according to the independent claim.

The invention lies in the technical field of treating a workpiece surface by means of roller burnishing. A defined surface structure, surface quality, or surface geometry is attained thereby in that the roller burnishing tool is rolled on the workpiece surface to be treated with a specified contact pressure, wherein the workpiece surface to be treated undergoes a plastic deformation.

The plastic deformation can also comprise a machining and can in particular consist in the roughening of the surface and simultaneously in the blunting of the roughened surface. One goal of surface treatments of this type lies, for example, in improving the wettability of the treated surface of the workpiece.

A conventional roller burnishing tool comprising a base body extending along a longitudinal central axis, a roller holder, which is arranged in a radially displaceable manner in a recess in the base body and on which a burnishing roller is supported, and a central adjusting means, which has an adjusting rod, which is axially displaceable in the base body, comprising a control bevel, which runs obliquely to the central longitudinal axis and against which the roller holder bears in a flat manner, is specified in DE 20 2009 014 180 U1 or DE 10 2012 207 455 A1.

A functionally improved roller burnishing tool is known from DE 10 2017 213 045 A1.

When treating surfaces, in particular to create a structured surface (e.g. microgroove structure, trapezoidal structure, etc.), it has been shown with regard to the treatment speed and the treatment quality that it is disadvantageous when the external surface of the burnishing roller is too smooth.

The invention is based on the object of providing a roller burnishing tool, which provides for a good treatment of workpieces, with simultaneously high treatment speed.

The object is solved by means of a roller burnishing tool according to the independent claim. Advantageous aspects form the subject matter of the respective subclaims.

The invention comprises a roller burnishing tool comprising a base body comprising at least one roller holder, which is arranged in a radially adjustable manner. At least one burnishing roller is arranged in a rotationally movable manner on every roller holder. The at least one burnishing roller has an external surface comprising a rough working section with a predetermined roughness depth. The rough working section allows for a treatment of a workpiece by means of roller burnishing with high treatment quality and speed.

According to a particularly preferred aspect, the roughness depth of the working section is in the range of from 2 μm to 400 μm, in particular in the range of from 5 μm to 100 μm. The roughness depth is the average value of the roughness values of the working section measured by means of a perthometer (e.g. profile method).

It is further advantageous when the working section comprises a diamond material. The diamond material can consist of small diamond particles, which are applied to the working surface.

Particularly preferably, the diamond material is arranged in a solder mass. The solder mass is a metallic alloy with a sufficient hardness in order to firmly hold the diamond particles therein.

According to a further technical aspect, the working section comprises a solid carbide material. In the case of the solid carbide material, hard materials are held together as small particles in a matrix made of metal.

According to a technically advantageous aspect, the solid carbide material is formed in such a way that the roughness has been created by means of laser.

According to an alternative or additive aspect, the solid carbide material is formed in such a way that the roughness has been created by means of grinding. The grinding comprises every machining until the predetermined roughness is attained.

According to an alternative or additive aspect, the solid carbide material is formed in such a way that the roughness has been created by means of coating. A coating is thereby applied according to the desired roughness.

Another aspect of the invention relates to a method for producing a burnishing roller comprising the following steps:
providing a burnishing roller comprising a working section;
roughening a surface of the working section by means of
a) lasering
b) grinding and/or
c) coating.

The invention will be additionally described below on the basis of the examples, which are illustrated in the drawings, in which:

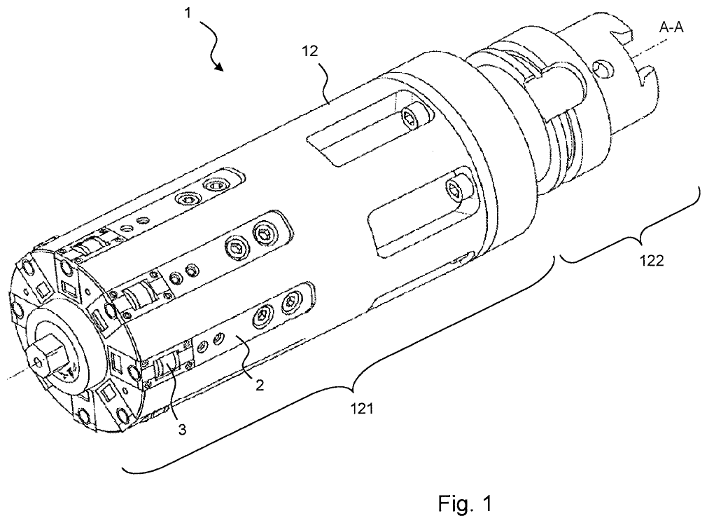

FIG. 1 shows a roller burnishing tool according to an example for the invention; and

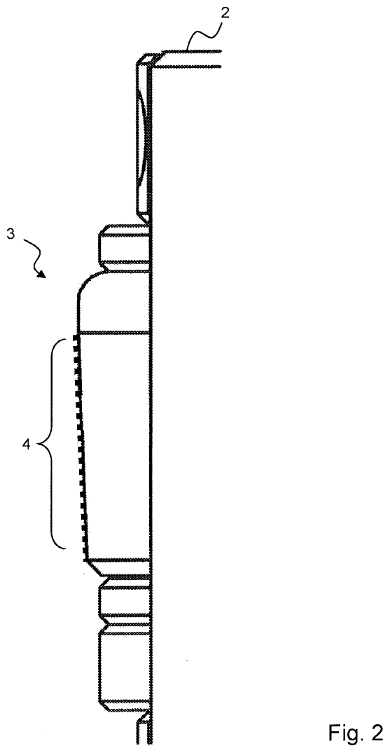

FIG. 2 shows a view of a partial section through a burnishing roller for the roller burnishing tool from FIG. 1.

FIG. 1 shows a perspective illustration of a roller burnishing tool 1 for treating a workpiece surface, in particular for roughening or blunting a roughened workpiece surface.

The roller burnishing tool 1 has a base body 12 comprising a tool section 121 and a fastening section 122 for arrangement in a rotating drive tool (not illustrated).

Eight roller holders 2, which are arranged in a radially adjustable manner, are illustrated on the tool section 121 of the base body. Every roller holder 2 comprises a receptacle for burnishing rollers 3, which in each case rotates about separate axes of rotation, which lie parallel to the base body axis A-A.

A burnishing roller 3 is arranged in a rotationally movable manner on every roller holder 2. In the shown example, every or every second burnishing roller 3 has an external surface comprising a rough working section (see FIG. 4) with a predetermined roughness depth, in order to provide for a treatment of a workpiece by means of roller burnishing with high treatment quality and speed.

The burnishing roller 3 arranged in the roller holder 2 is illustrated in detail in FIG. 2, wherein the external surface has a rough working section 4 with a roughness depth in the range of from 2 μm to 400 μm. The roughness is illustrated by means of the dotted line.

Various alternatives for the design of the surface of the working section 4 can be described using the shown example for the burnishing roller 3. All alternatives can lead to the mentioned roughness depth.

In a first alternative, the working section 4 comprises a diamond material. In the shown example, these are small diamond particles made of artificially produced industrial diamonds. The diamond particles are arranged in a solder mass in such a way as to firmly adhere to the burnishing roller 3 on the one hand, and to ensure a good roughness and a high hardness of the surface on the other hand.

Another alternative provides that the working section 4 comprises a solid carbide material, which is realized most simply in that the entire burnishing roller 3 consists of a single solid carbide material.

In a first example, the solid carbide material is formed in such a way that the roughness has been created by means of laser. A laser is thereby used to treat the surface of the working section. The surface treatment provides that the laser radiation penetrates into the material only in the region of the predetermined roughness depth.

Another example provides that the solid carbide material is formed in such a way that the roughness has been created by means of grinding. During the grinding, the material removal takes place in such a way that the above-described roughness depth is realized.

The last example provides that the solid carbide material is formed in such a way that the roughness has been created by means of coating. Rough metal alloys can be applied here, in order to create the desired roughness depth.

1. A roller burnishing tool for treating a workpiece surface comprising a base body comprising at least one roller holder, which is arranged in a radially adjustable manner, wherein a burnishing roller is arranged in a rotationally movable manner on every roller holder, and wherein at least one burnishing roller has an external surface comprising a rough working section with a predetermined roughness depth.

2. The roller burnishing tool according to claim 1, wherein the roughness depth of the working section is in the range of from 2 μm to 400 μm.

3. The roller burnishing tool according to claim 1, wherein the working section comprises a diamond material.

4. The roller burnishing tool according to claim 3, wherein the diamond material is arranged in a solder mass.

5. The roller burnishing tool according to claim 1, wherein the working section comprises a solid carbide material.

6. The roller burnishing tool according to claim 5, wherein the solid carbide material is formed in such a way that the roughness has been created by means of laser.

7. The roller burnishing tool according to claim 5, wherein the solid carbide material is formed in such a way that the roughness has been created by means of grinding.

8. The roller burnishing tool according to claim 5, wherein the solid carbide material is formed in such a way that the roughness has been created by means of coating.

9. A method for producing a burnishing roller comprising the following steps:
providing a burnishing roller comprising a working section;
roughening a surface of the working section by:
a) lasering
b) grinding and/or
c) coating.

10. The roller burnishing tool according to claim 1, wherein the roughness depth of the working section is in the range of from 5 μm to 100 μm.
